(19) United States
(12) Patent Application Publication
(10) Pub. No.: US 2016/0358512 A1
(43) Pub. Date: Dec. 8, 2016

(54) Training Utensil for Utensil Handling Practice

(71) Applicant: Natasha Gonshor, Kailua Kona, HI (US)

(72) Inventor: Natasha Gonshor, Kailua Kona, HI (US)

(21) Appl. No.: 15/172,515

(22) Filed: Jun. 3, 2016

Related U.S. Application Data
(60) Provisional application No. 62/170,287, filed on Jun. 3, 2015.

(51) Int. Cl. G09B 19/24; A47G 21/04; B26B 3/02; A47G 21/02

(52) U.S. Cl. CPC G09B 19/24; A47G 21/02; A47G 21/04; B26B 3/02

(57) ABSTRACT

An eating utensil for utensil handling training has a central handle member with a proximal end and a distal end, with a first grasping member and a second grasping member being laterally connected to the central handle member between the proximal end and the distal end. The first and second grasping members are configured to receive and support a user's fingers. The grasping members may be tubular bodies with internal cavities into which the fingers are inserted, or the grasping members may be ringed bodies. A central cavity of the central handle member offers additional utility for receiving a third finger. A utensil head is connected to the distal end, and can be configured as one of multiple types of utensil heads.

The current application claims a priority to the U.S. Provisional Patent application Ser. No. 62/170,287 filed on Jun. 3, 2015.

### FIELD OF THE INVENTION

The present invention relates generally to eating utensils. More particularly, the present invention relates to modified utensils for utensil handling practice in children.

### BACKGROUND OF THE INVENTION

An eating utensil is a tool for shaping and carrying food to the mouth. People in different cultures use a variety of tools to eat. These may be known as eating utensils. May different types of eating utensils exist, including general utensils such as forks, spoons, sporks, knives, chopsticks, skewers, and tongs, combination utensils consisting of various combinations of general utensils, and utensils for specific foods such as crab forks, fondue forks, grapefruit knives, grapefruit spoons, lobster picks, and other food-specific utensils.

Children often struggle with utensils when learning to eat, do to their lack of refined motor skills. Children may drop the utensils or otherwise find difficulty in adapting to the process of mechanically manipulating a utensil to adequately transport food to their mouth. This struggle may affect a child's confidence because they cannot eat meals independently of their parents.

It is therefore an object of the present invention to present a novel utensil that provides a structure and arrangement that facilitates enhanced ease of use for manipulating utensils to eat in comparison to standard utensils which require being gripped with more developed motor skills. The present invention accomplishes this purpose through the use of two or more grasping members affixed to the central handle member into which a child may insert their fingers, obviating the use of their fingers to directly grip the central handle member.

### BRIEF DESCRIPTION OF THE DRAWINGS

FIG. 1 is a perspective view of one embodiment of the present invention.

FIG. 2 is a rear perspective view of one embodiment of the present invention.

FIG. 3 is an exploded view of one embodiment of the present invention.

FIG. 4 is a rear perspective view of one embodiment of the present invention where the grasping members comprise ringed bodies.

FIG. 5 is a perspective view of one embodiment of the present invention where the utensil head is a spoon head.

FIG. 6 is a perspective view of one embodiment of the present invention where the utensil head is a spork head.

FIG. 7 is a perspective view of one embodiment of the present invention where the utensil head is a knife head.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a training utensil for utensil handling practice, particularly for use in small children who have not yet developed the fine motor skills required to adequately manipulate a standard utensil to consume food.

The present invention may be manufactured or otherwise created through any desirable means, such as, but not limited to, casting, molding, forming, forging, extrusion, pressing, bending, shearing, machining, joining, additive manufacturing, 3D printing, any other relevant, useful and/or desirable manufacturing process or any combination of the aforementioned processes. The material of the present invention may be any suitable material, such as, but not limited to, one or more metals, plastics, ceramics, composites, or any relevant, useful and/or desirable combination of the aforementioned materials.

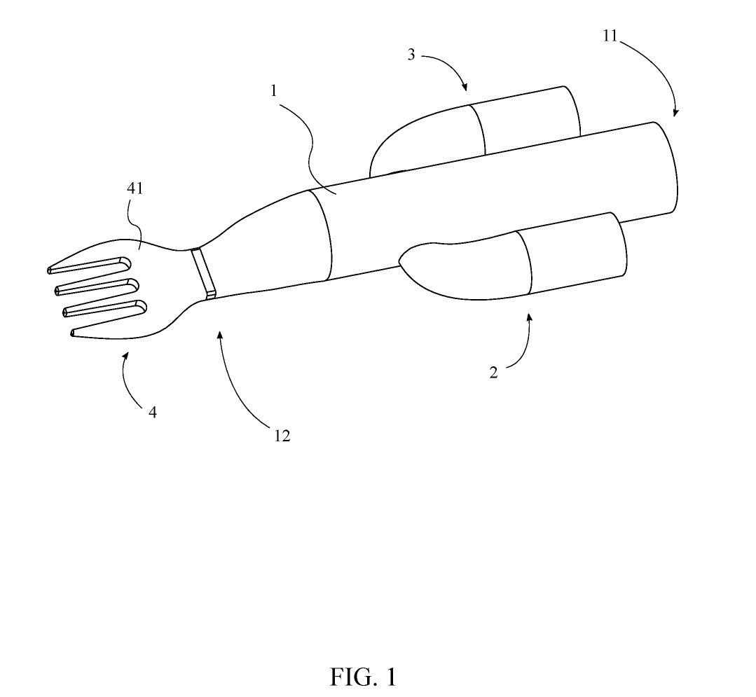

Referring to FIG. 1, in one embodiment, the present invention comprises a central handle member 1, a first grasping member 2, a second grasping member 3, and a utensil head 4. The central handle member 1 forms the primary structural component of the present invention and support the other components. The central handle member 1 comprises a proximal end 11 and a distal end 12. The proximal end 11 and the distal end 12 are positioned longitudinally opposite each other along the central handle member 1. The proximal end 11 is the end adjacent to the user's hand when in use, and the distal end 12 is the end which manipulates food.

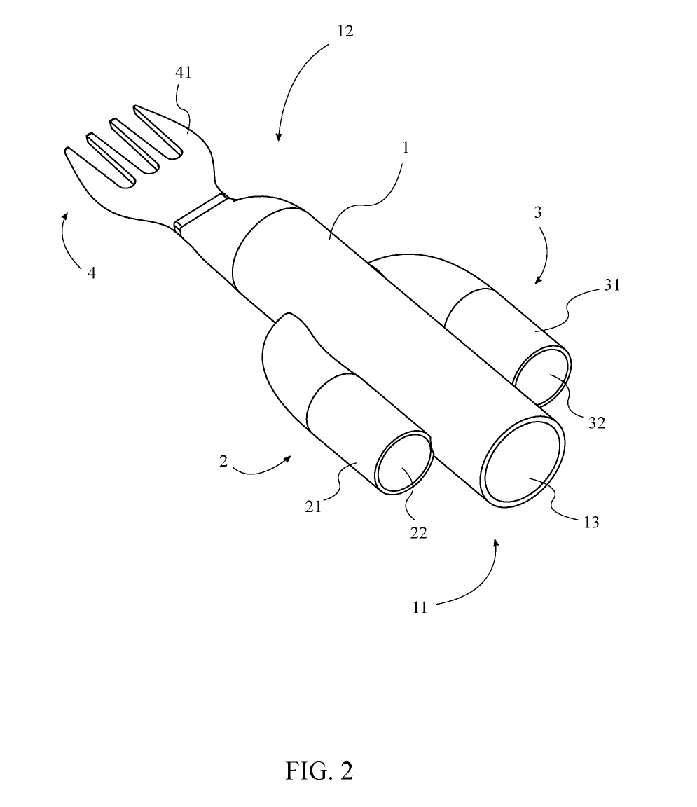

In one embodiment of the present invention, as can be seen in FIG. 2, the central handle member 1 is hollow, with the central handle member 1 further comprising a central cavity 13, the central cavity 13 of the central handle member 1 longitudinally traversing into the central handle member 1 from the proximal end 11 toward the distal end 12. Thus, in this embodiment, a third point of contact is provided for the user, wherein in addition to two of the user's fingers being engaged into the first grasping member 2 and the second grasping member 3, a third finger may be engaged into the hole provided by the entrance to the central cavity 13 of the central handle member 1. In another embodiment, the central handle member 1 does not comprise the central cavity 13, and thus the proximal end 11 of the central handle member 1 is solid and does not have a hole for a third finger of the user.

The first grasping member 2 and the second grasping member 3 form the primary unique modification of the present invention to a standard utensil, providing multiple structural elements into which a user may insert their fingers, forming a friction fit between their fingers and the grasping members, allowing the user to manipulate the present invention more easily by simply moving their fingers instead of being required to wrap their fingers around and apply gripping force to a standard utensil. The first grasping member 2 and the second grasping member 3 are positioned adjacent to the central handle member 1 between the proximal end 11 and the distal end 12. The first grasping member 2 and the second grasping member 3 are configured to receive and support the user's fingers therein. In one embodiment, one of the grasping members is configured to receive and support the user's thumb, while the other grasping member is configured to receive the user's index finger for maximum utility.

In one embodiment, the first grasping member 2 and the second grasping member 3 are connected directly to the central handle member 1, being injection molded into the aforementioned form, or glued, or affixed through one or more fasteners, or another means of connection between the central handle member 1 and the first grasping member 2 and second grasping member 3, or any of the aforementioned manufacturing processes.

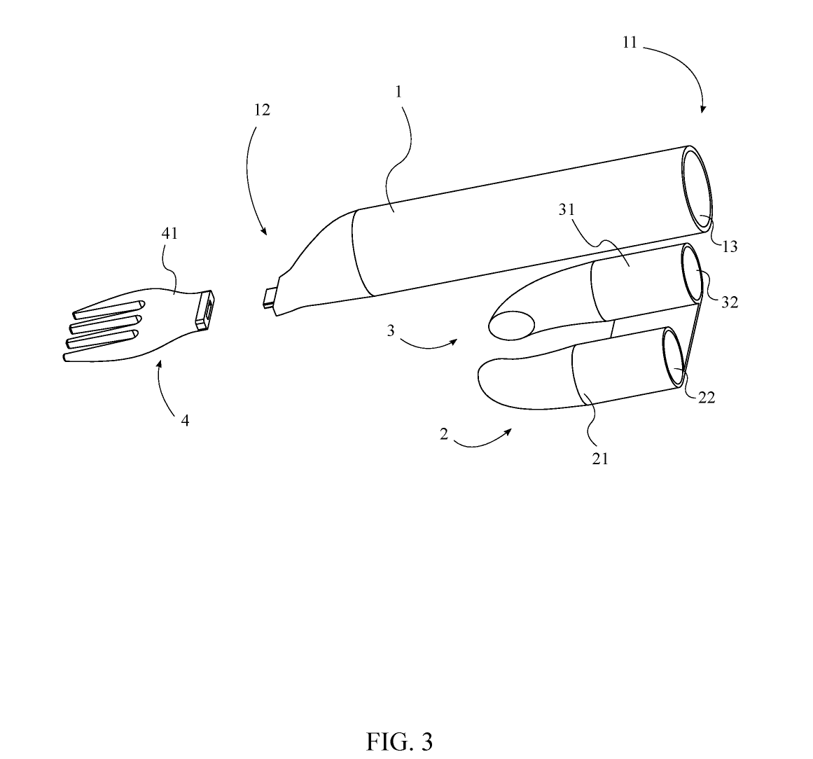

In one embodiment, the first grasping member 2 and the second grasping member 3 are removably attached to the central handle member 1. The first grasping member 2 and the second grasping member 3 may be removably attached to the central handle member 1 through any useful means. In one embodiment, the first grasping member 2 and the second grasping member 3 are connected to each other by a bridging portion, forming a saddle-like shape which is formed and configured to receive the central handle member 1 in a friction fit or snap-on design, as illustrated in the exploded view of FIG. 3, or with one or more fasteners, or through other relevant means. In one embodiment, the first grasping member 2 and the second grasping member 3 may be independently attached to the central handle member 1 through any relevant means. For example, the first grasping member 2 and the second grasping member 3 may comprise a protrusion, while the central handle member 1 comprises two slots, into which the protrusions of the grasping members are inserted. Inversely, the central handle member 1 may comprise the protrusions while the grasping members comprise the slots, which are affixed onto the slots of the central handle member 1. In one embodiment, the protrusions are slid into grooves, affixing the grasping members in place adjacent to the central handle member 1.

In one embodiment, the first grasping member 2 and the second grasping member 3 are positioned laterally opposite each other along the central handle member 1, being oriented symmetrically about a central axis of the central handle member 1. In various embodiments, however, the first grasping member 2 and the second grasping member 3 may be positioned in various alternate arrangements in relation to the central handle member 1. For example, in one embodiment the first grasping member 2 and the second grasping member 3 may be positioned at 90 degrees to each other relative to the central axis of the central handle member 1, or at any other radial orientations relative to each other. In one embodiment the first grasping member 2 and the second grasping member 3 may be positioned longitudinally offset from each other, with one of the grasping members being positioned closer to the proximal end 11 and one of the grasping members being positioned closer to the distal end 12.

In one embodiment, the first grasping member 2 comprises a first tubular body 21 and a first cavity 22, while the second grasping member 3 comprises a second tubular body 31 and a second cavity 32. The first cavity 22 traverses distally, or toward the distal end 12, into the first tubular body 21, with an opening into the first tubular body 21 being positioned adjacent to the proximal end 11 of the central handle member 1. Similarly, the second cavity 32 traverses distally into the second tubular body 31, with an opening of the second tubular body 31 being positioned adjacent to the proximal end 11 of the central handle member 1. The first tubular body 21 and the second tubular body 31 serve to receive a first and second finger of the user in order to physically manipulate the present invention. In one embodiment, the first tubular body 21 and the second tubular body 31 are tapered at the ends of the tubular bodies closer to the distal end 12 of the central handle member 1, enabling a mild friction fit between the user's fingers and the tubular bodies to prevent the present invention from slipping off the user's fingers while in use. In one embodiment, the first tubular body 21 and the second tubular body 31 are oriented longitudinally, parallel to the central handle member 1. It is contemplated that in various other embodiments, the first tubular body 21 and the second tubular body 31 may be oriented at various different angles relative to each other and to the central handle member 1 in order to facilitate alternative ergonomic arrangements.

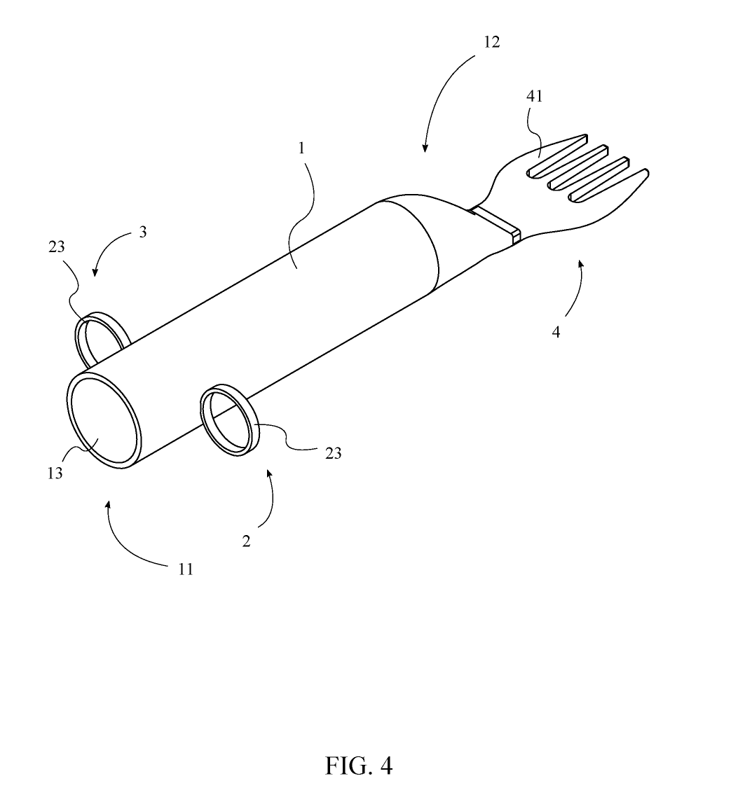

In one embodiment shown in FIG. 4, the first grasping member 2 and the second grasping member 3 each comprise a ringed body 23. In this embodiment, the first grasping member 2 and the second grasping member 3 are essentially a cross-section of the tubular bodies from the previously described configuration, with the user's fingers being inserted through the ringed body 23 of the first grasping member 2 and the second grasping member 3 in order to grasp the present invention. The ringed body 23 arrangement may present a benefit in allowing the tips of the user's fingers to move freely, allowing the user to engage in tactile sensation or manipulation of objects outside the present invention and preventing discomfort from the user's fingers being completely enclosed and restrained.

It is further contemplated that the present invention should not be restricted to solely the first grasping member 2 and the second grasping member 3, and various embodiments may comprise additional grasping members, such as, but not limited to, a third grasping member, a fourth grasping member, and a fifth grasping member, to be embodied in any desired configuration. It is further contemplated that the first grasping member 2, the second grasping member 3, and any additional grasping member should not be limited into all belonging to the tubular body embodiment or the ringed body embodiment, and any desired mix of tubular bodies and ringed bodies may be utilized in various different arrangements for various different grasping members.

The utensil head 4 is the working end of the present invention. The utensil head 4 is positioned adjacent to the central handle member 1 at the distal end 12. In one embodiment, the utensil head 4 is oriented symmetrically about the central axis of the central handle member 1. In various other embodiments, the utensil head 4 may be oriented at any other orientation to the central handle member 1. In one embodiment, the utensil head 4 is permanently connected to the central handle member 1 at the distal end 12. In one embodiment, the utensil head 4 is removably attached to the central handle member 1 at the distal end 12. The utensil head 4 may be removably attached to the central handle member 1 using any applicable means. For example, the central handle member 1 may comprise a distal extrusion at the distal end 12, while the utensil head 4 comprises a utensil head 4 cavity, as shown in FIG. 3. The utensil head 4 may be attached to the central handle member 1 by inserting the distal extrusion into the utensil head 4 cavity, forming a friction fit which can be reversed through an appropriate amount of pulling force. Alternatively, a latch or other fastener may be utilized, or other applicable geometrically mated means may be utilized.

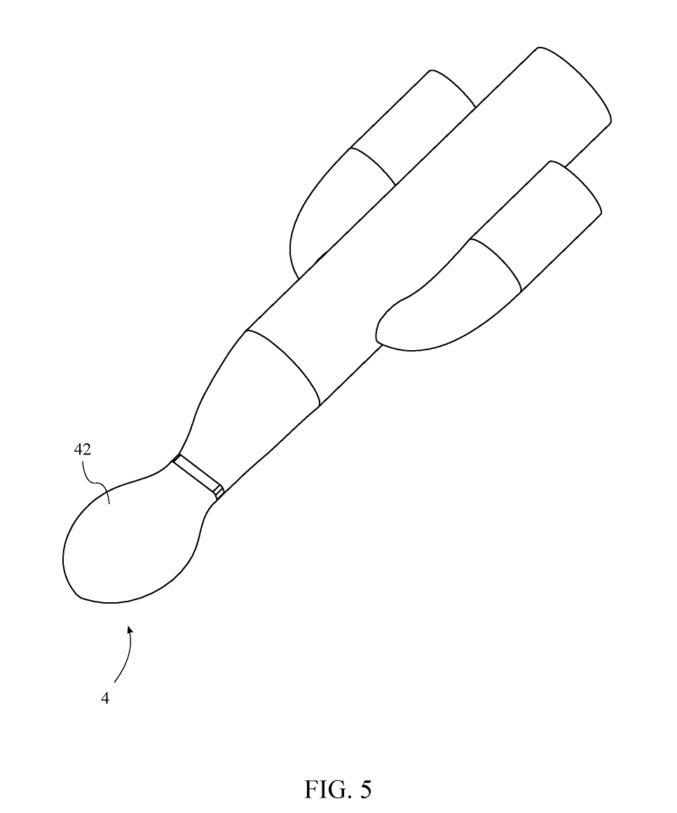

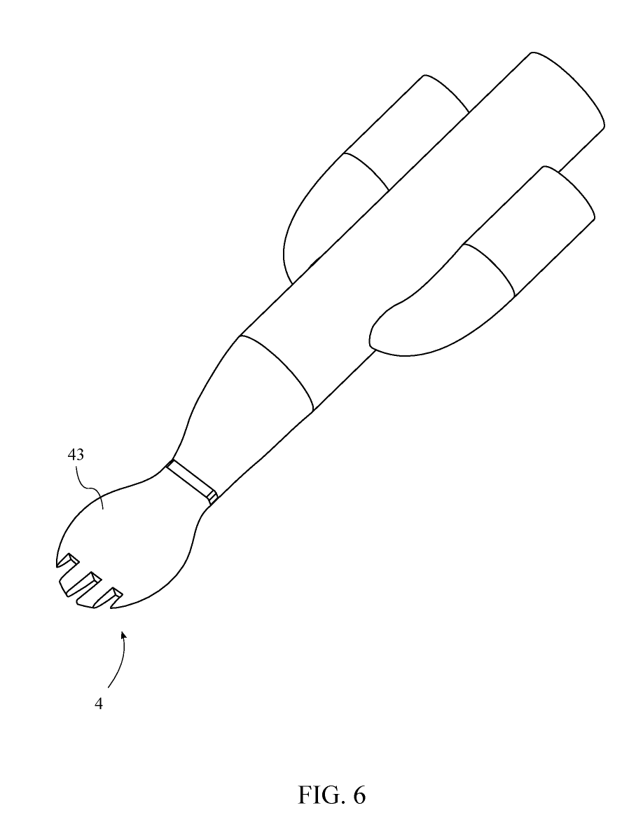

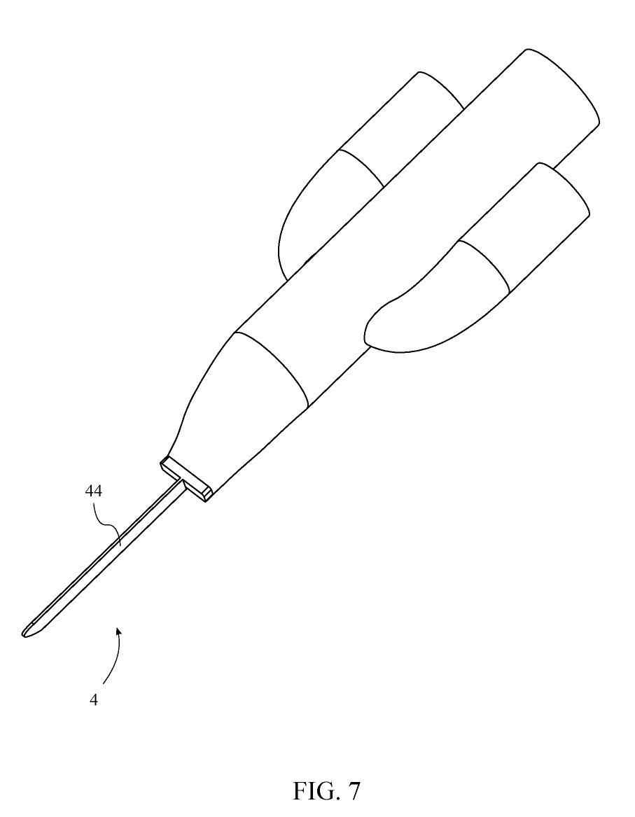

The utensil head 4 may take the form of any applicable typical or non-typical eating utensil head 4. In one embodiment shown in FIGS. 1-4, the utensil head 4 is a fork head 41. In one embodiment shown in FIG. 5, the utensil head 4 is a spoon head 42. In one embodiment shown in FIG. 6, the utensil head 4 is a spork head 43. In one embodiment shown in FIG. 7, the utensil head 4 is a knife head 44.

In view of the foregoing disclosure, the present invention presents a useful and novel apparatus for assisting children or other motor skill impaired persons to more easily and comfortably eat food in comparison to current eating implements, and which will instill confidence in the child because they are able to each food like adults, aiding their self-esteem. Overall, the present invention is a device that may not only assist children to eat independently, but will also act as a learning tool and a confidence builder.

Although the invention has been explained in relation to its preferred embodiment, it is to be understood that many other possible modifications and variations can be made without departing from the spirit and scope of the invention as hereinafter claimed.

What is claimed is:

1. A training utensil for utensil handling practice comprises:
a central handle member;
a first grasping member;
a second grasping member;
a utensil head;
the central handle member comprises a proximal end and a distal end, wherein the proximal end and the distal end are positioned longitudinally opposite each other along the central handle member;
the first grasping member and the second grasping member being positioned adjacent to the central handle member between the proximal end and the distal end; and
the utensil head being positioned adjacent to the central handle member at the distal end.

2. The eating utensil for utensil handling training as claimed in claim 1 comprises:
the central handle member further comprises a central cavity; and
the central cavity of the central handle member longitudinally traversing into the central handle member from the proximal end toward the distal end.

3. The eating utensil for utensil handling training as claimed in claim 1 comprises:
the first grasping member and the second grasping member being connected to the central handle member.

4. The eating utensil for utensil handling training as claimed in claim 1 comprises:
the first grasping member and the second grasping member being removably attached to the central handle member.

5. The eating utensil for utensil handling training as claimed in claim 1 comprises:
the first grasping member and the second grasping member being positioned laterally opposite each other along the central handle member.

6. The eating utensil for utensil handling training as claimed in claim 1 comprises:
the first grasping member comprises a first tubular body and a first cavity;
the second grasping member comprises a second tubular body and a second cavity;
the first cavity traversing distally into the first tubular body; and
the second cavity traversing distally into the second tubular body.

7. The eating utensil for utensil handling training as claimed in claim 6 comprises:
the first tubular body and the second tubular body being oriented parallel to the central handle member.

8. The eating utensil for utensil handling training as claimed in claim 1 comprises:
the first grasping member and the second grasping member each comprise a ringed body.

9. The eating utensil for utensil handling training as claimed in claim 1 comprises:
the utensil head being connected to the central handle member at the distal end.

10. The eating utensil for utensil handling training as claimed in claim 1 comprises:
the utensil head being removably attached to the central handle member at the distal end.

11. The eating utensil for utensil handling training as claimed in claim 1 comprises:
the utensil head being a fork head.

12. The eating utensil for utensil handling training as claimed in claim 1 comprises:
the utensil head being a spoon head.

13. The eating utensil for utensil handling training as claimed in claim 1 comprises:
the utensil head being a spork head.

14. The eating utensil for utensil handling training as claimed in claim 1 comprises:
the utensil head being a knife head.
